(19) United States
(12) Patent Application Publication
(10) Pub. No.: US 2018/0276574 A1
(43) Pub. Date: Sep. 27, 2018

(54) SEAT RESERVATION SYSTEM, INFORMATION PROCESSING DEVICE, INFORMATION PROCESSING METHOD, AND RECORDING MEDIUM

(71) Applicant: NEC Corporation, Minato-ku, Tokyo (JP)

(72) Inventor: Yasunori MORIMOTO, Tokyo (JP)

(73) Assignee: NEC Corporation, Minato-ku, Tokyo (JP)

(21) Appl. No.: 15/763,555

(22) PCT Filed: Sep. 15, 2016
(86) PCT No.: PCT/JP2016/004205

§ 371 Date: Mar. 27, 2018

(30) Foreign Application Priority Data
Sep. 30, 2015 (JP) 2015-195041

(51) Int. Cl. G06Q 10/02; G06K 7/10

(52) U.S. Cl. CPC G06Q 10/02; G06K 7/10297

(57) ABSTRACT

[Problem] To provide a technique capable of accurately grasping a usage status of each seat, while suppressing an overall system cost.

[Solution] A seat reservation system 1 includes a tray detection unit 110 provided for each seat at a table, and configured to detect a presence or absence of a tray, a vacant seat information generation unit 210 for generating vacant seat information indicating that a seat for which a tray is not continuously detected for a predetermined time or longer by the tray detection unit 110 is a vacant seat, a reservation processing unit 220 for performing seat reservation processing by using vacant seat information, and a seat reservation information output unit 310 for outputting seat reservation information indicating a seat reserved by reservation processing.

### TECHNICAL FIELD

The present invention relates to a technique for managing a usage status of a seat space.

### BACKGROUND ART

Examples of a system for managing a usage status of a seat space for customers, which are located within a shop or located near the shop, are disclosed in PTL 1 and PTL 2. PTL 1 discloses a technique for judging a usage status of each seat by using a detection result of a detection sensor for detecting that a person is seated, and a reading result of a reading device for reading an RF-ID tag provided on a tray. Further, PTL 2 discloses a technique for judging a usage status of each seat, based on a detection result of a seat sensor (an ultrasonic sensor, a load sensor, a temperature sensor, or an image sensor) provided for a seat. Further, PTL 3 discloses a technique for managing vacant seat information.

### CITATION LIST

### Patent Literature

[PTL 1] Japanese Laid-open Patent Publication No. 2006-39748

[PTL 2] Japanese Laid-open Patent Publication No. H11-272784

[PTL 3] Japanese Laid-open Patent Publication No. 2003-99514

### SUMMARY OF INVENTION

### Technical Problem

As compared with a technique described in PTL 2, a technique disclosed in PTL 1 is able to accurately judge a usage status of each seat by using two types of information (a reading result of an IC tag and a detection result of a detection sensor). However, in PTL 1, since two types of sensors are necessary for each seat, as the number of seats increases, an overall system cost may increase. Further, PTL 3 is not sufficient as a technique for grasping a usage status of each seat.

An object of the present invention is to provide a technique capable of accurately grasping a usage status of each seat, while suppressing an overall system cost.

### Solution to Problem

According to the present invention, provided is a seat reservation system including:

a tray detection means provided for each seat at a table, and configured to detect a presence or absence of a tray;

a vacant seat information generation means for generating vacant seat information indicating that a seat for which a tray is not continuously detected for a predetermined time or longer by the tray detection means is a vacant seat;

a reservation processing means for performing seat reservation processing by using the vacant seat information; and

a seat reservation information output means for outputting seat reservation information indicating a seat reserved by the reservation processing.

According to the present invention, provided is an information processing device including:

a vacant seat information generation means for generating vacant seat information indicating that a seat for which a tray is not continuously detected for a predetermined time or longer by a tray detection means for detecting a presence or absence of a tray is a vacant seat; and

a reservation processing means for performing seat reservation processing by using the vacant seat information, wherein

the tray detection means is provided for each seat at a table.

According to the present invention, provided is an information processing method including:

generating vacant seat information indicating that a seat for which a tray is not continuously detected for a predetermined time or longer by a tray detection means is a vacant seat by using a detection result by the tray detection means provided for each seat at a table; and

performing seat reservation processing by using the vacant seat information.

According to the present invention, provided is a program for causing a computer to function as:

a vacant seat information generation means for generating vacant seat information indicating that a seat for which a tray is not continuously detected for a predetermined time or longer by a tray detection means is a vacant seat by using a detection result by the tray detection means provided for each seat at a table;

a reservation processing means for performing seat reservation processing by using the vacant seat information; and

a seat reservation information output means for outputting seat reservation information indicating a seat reserved by the reservation processing.

### Advantageous Effects of Invention

According to the present invention, it is possible to enhance a seat turnover rate of customers, while suppressing labor and an installation cost.

### BRIEF DESCRIPTION OF DRAWINGS

FIG. 1 is a diagram conceptually illustrating a system configuration of a seat reservation system in a first example embodiment.

FIG. 2 is a diagram illustrating an example of information stored in a vacant seat information storage unit in the first example embodiment.

FIG. 3 is a diagram conceptually illustrating a hardware configuration of the seat reservation system in the first example embodiment.

FIG. 4 is a sequence diagram illustrating a processing flow of updating vacant seat information to be performed by a vacant seat information generation unit in the first example embodiment.

FIG. 5 is a sequence diagram illustrating an example of a flow of seat reservation to be performed by a reservation processing unit in the first example embodiment.

FIG. 6 is a diagram conceptually illustrating a system configuration of a seat reservation system in a second example embodiment.

FIG. 7 is a diagram illustrating an example of information stored in a group information storage unit.

FIG. 8 is a diagram illustrating an example of information stored in a vacant seat information storage unit in the second example embodiment.

FIG. 9 is a sequence diagram illustrating a processing flow of generating group information by a group information generation unit.

FIG. 10 is a sequence diagram illustrating an operation example of a server device and a shop terminal when seat reservation is performed by using a group ID.

FIG. 11 is a diagram conceptually illustrating a system configuration of a seat reservation system in a third example embodiment.

FIG. 12 is a diagram conceptually illustrating a hardware configuration of a group input terminal.

FIG. 13 is a sequence diagram illustrating a processing flow of generating group information by a group information generation unit in the third example embodiment.

FIG. 14 is a diagram conceptually illustrating a system configuration of a seat reservation system according to a fourth example embodiment.

FIG. 15 is a diagram conceptually illustrating a hardware configuration of a seat reservation device 40 in the fourth example embodiment.

FIG. 16 is a sequence diagram illustrating an example of an operation to be performed by the seat reservation device 40 together with an operation of a server device.

FIG. 17 is a diagram conceptually illustrating a system configuration of a seat reservation system according to a fifth example embodiment.

FIG. 18 is a diagram conceptually illustrating a hardware configuration of the seat reservation system in the fifth example embodiment.

FIG. 19 is a diagram illustrating an example of a data configuration of a vacant seat information storage unit in the fifth example embodiment.

FIG. 20 is a sequence diagram illustrating an operation of a server device and a shop terminal when a seat is reserved in the seat reservation system in the fifth example embodiment.

FIG. 21 is a sequence diagram illustrating an operation of a table and the server device when a customer uses a seat reserved in the seat reservation system in the fifth example embodiment.

### EXAMPLE EMBODIMENT

In the following, example embodiments of the present invention are described using the drawings. Note that in all the drawings, same constituent elements are indicated with same reference numerals, and repeated description thereof is omitted as necessary.

### First Example Embodiment

(System Configuration)

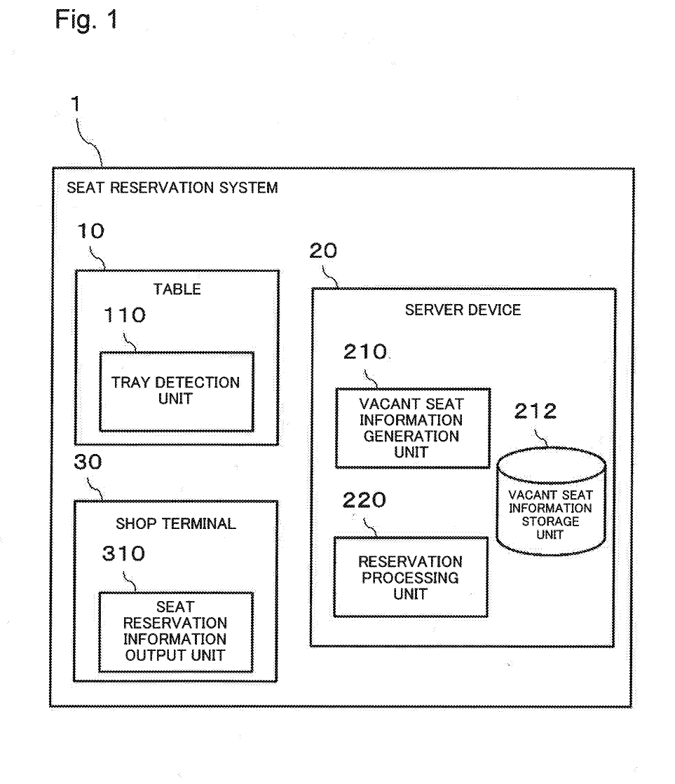

FIG. 1 is a diagram conceptually illustrating a system configuration of a seat reservation system 1 in a first example embodiment. As illustrated in FIG. 1, the seat reservation system 1 is constituted by including a table 10, a server device 20, and a shop terminal 30.

The table 10 is installed in a seat space where customers in a shop are free to use. A tray detection unit 110 for detecting a presence or absence of a tray is provided on each table 10. The tray detection unit 110 is provided for each seat at the table 10. The tray detection unit 110 detects a presence or absence of a tray by using a reader device for reading an IC tag (e.g. an RFID tag), a proximity sensor, or the like, for example.

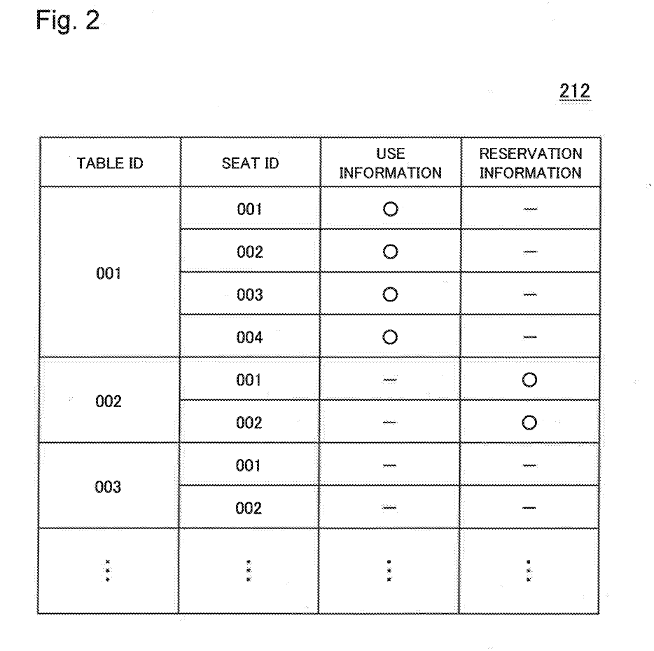

The server device 20 is an example of an information processing device, and manages a usage status of a seat space by receiving a tray detection result by the tray detection unit 110 on the table 10. Specifically, a vacant seat information generation unit 210 receives a detection result from the tray detection unit 110 on each table 10, and generates vacant seat information indicating which seat is vacant. More specifically, the vacant seat information generation unit 210 judges that a seat for which a tray is not continuously detected for a predetermined time by the tray detection unit 110 is a vacant seat. Then, the vacant seat information generation unit 210 stores vacant seat information generated from a detection result of the tray detection unit 110 on each table 10 into a vacant seat information storage unit 212. In an example of FIG. 1, the vacant seat information storage unit 212 is provided in the server device 20. Alternatively, the vacant seat information storage unit 212 may be provided in an external device communicatively connected to the server device 20. The vacant seat information storage unit 212 stores information as illustrated in FIG. 2, for example.

FIG. 2 is a diagram illustrating an example of information stored in the vacant seat information storage unit 212 in the first example embodiment.

In FIG. 2, the vacant seat information storage unit 212 stores information (use information) indicating whether or not a target seat is occupied, and information (reservation information) indicating whether or not the target seat is reserved, in association with information (table ID) for identifying each table and information (seat ID) for identifying each seat at the table. The use information is updated in accordance with a tray detection result by the tray detection unit 110. Further, the reservation information is updated in accordance with seat reservation processing by a reservation processing unit 220 as follows. Specifically, vacant seat information stored in the vacant seat information storage unit 212 is displayed on a display of a device such as the shop terminal 30 in response to a request from the device, and is used for determining a seat to be used by a customer. The reservation processing unit 220 receives input information indicating selecting a seat via an unillustrated input device, and updates a “reservation information” column of vacant seat information stored in the vacant seat information storage unit 212 by using the input information.

The shop terminal 30 is provided in each shop, and is a terminal for performing settlement processing of commodity, and the like. The shop terminal 30 is a point of sale (POS) device, for example. The shop terminal 30 may be a stationary terminal, or may be a mobile terminal such as a tablet terminal. A seat reservation information output unit 310 outputs information indicating a seat reserved by the reservation processing unit 220. Herein, “output” includes print output to a paper medium, and short-range communication and communication output via a network such as a notification message and a mail, for example.

[Hardware Configuration]

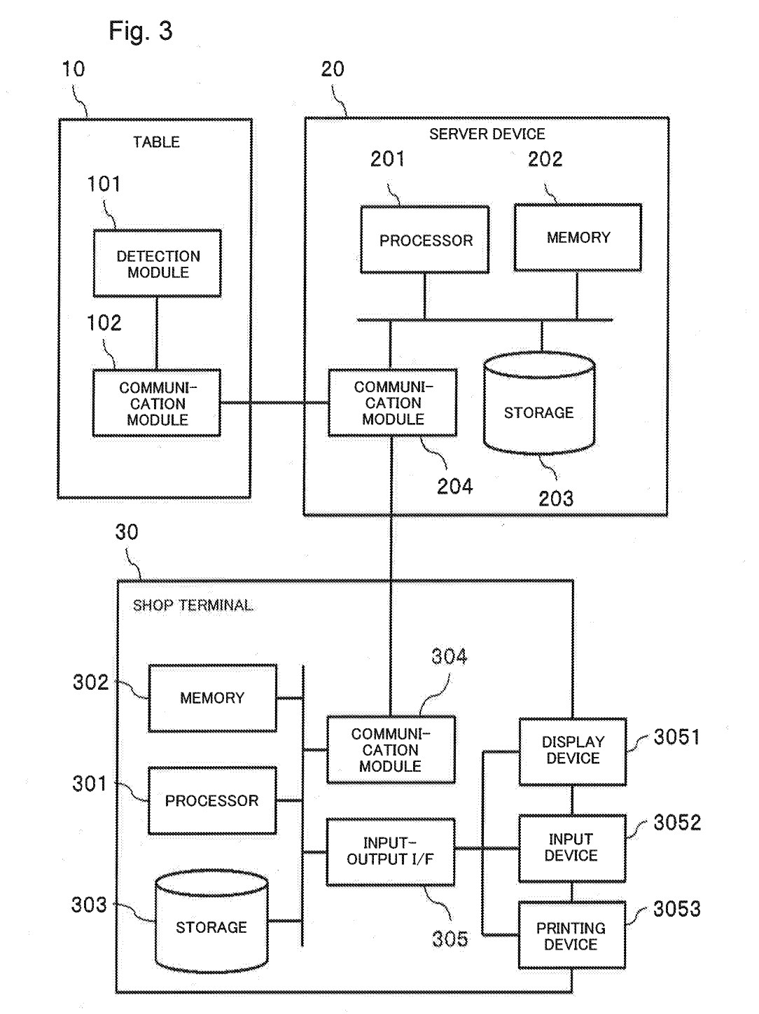

FIG. 3 is a diagram conceptually illustrating a hardware configuration of the seat reservation system 1 in the first example embodiment.

<Hardware Configuration of Device Provided on Each Table 10>

A device including a detection module 101 for detecting a presence or absence of a tray, and a communication module 102 for communicating with an external device via a wired or wireless network is provided on each table 10. The detection module 101 is constituted by including an IC tag reader, a proximity sensor, or the like, for example. The communication module 102 communicates with the server device 20, and transmits a detection result by the detection module.

<Hardware Configuration of Server Device 20>

The server device 20 includes a processor 201, a memory 202, a storage 203, and a communication module 204. The processor 201, the memory 202, the storage 203, and the communication module 204 are connected by a data transmission path for mutually transmitting and receiving data.

The processor 201 is an arithmetic processing device such as a central processing unit (CPU) and a graphics processing unit (GPU), for example. The memory 202 is, for example, a memory such as a random access memory (RAM) and a read only memory (ROM). The storage 203 is a storage device such as a hard disk drive (HDD), a solid state drive (SSD), and a memory card, for example. Further, the storage 203 may be a memory such as an RAM and an ROM.

The storage 203 stores a program for implementing a function of each processing unit (such as the vacant seat information generation unit 210 and the reservation processing unit 220) provided in the server device 20. The processor 201 implements functions of the respective processing units by executing these programs. Herein, when the aforementioned programs are executed, the processor 201 may execute these programs after reading these programs on the memory 202, or may execute these programs without reading these programs on the memory 202. Further, the storage 203 also functions as the vacant seat information storage unit 212.

The communication module 204 transmits and receives data to and from an external device via a wired network or a wireless network. For example, the server device 20 receives a tray detection result by the detection module 101 on the table 10 by using the communication module 204. Further, the server device 20 transmits vacant seat information stored in the vacant seat information storage unit 212 to the shop terminal 30 by using the communication module 204.

<Hardware Configuration of Shop Terminal 30>

The shop terminal 30 includes a processor 301, a memory 302, a storage 303, a communication module 304, and an input-output interface (I/F) 305. The processor 301, the memory 302, the storage 303, the communication module 304, and the input-output interface (I/F) 305 are connected by a data transmission path for mutually transmitting and receiving data.

The processor 301, the memory 302, and the storage 303 are the same as those in the server device 20. Various programs for implementing a settlement function of commodity are stored in the storage 303, in addition to a program for implementing a function of the seat reservation information output unit 310. By causing the processor 301 to execute these programs, various functions of the shop terminal 30 including the seat reservation information output unit 310 are implemented.

The communication module 304 transmits and receives data to and from an external device via a wired network or a wireless network. The shop terminal 30 transmits a request for transmitting vacant seat information to the server device 20 by using the communication module 304, and receives vacant seat information transmitted from the server device 20 in response to the transmission request. Further, the communication module 304 is able to perform short-range wireless communication such as Bluetooth (registered trademark). The shop terminal 30 transmits, to a mobile terminal of a customer in a shop, information indicating a seat reserved by short-range wireless communication, for example.

The input-output interface 305 is connected to a display device 3051, an input device 3052, a printing device 3053, and the like. The display device 3051 is a device for displaying a screen associated with drawing data processed by the processor 301, such as a liquid crystal display (LCD), and a cathode ray tube (CRT) display. The input device 3052 is a device for receiving an operation input by an operator, and is a keyboard, a mouse, a touch sensor, and the like, for example. The display device 3051 and the input device 3052 may be integrally formed, and implemented as a touch panel. The printing device 3053 includes a mechanism for feeding preset printing paper, a mechanism for printing printing data processed by the processor 301 on the printing paper, and a mechanism for cutting the printing paper. Each mechanism of the printing device 3053 is operated according to a control command to be transmitted from the processor 301.

Note that a hardware configuration of the seat reservation system 1 is not limited to a configuration in FIG. 3.

[Operation Example]

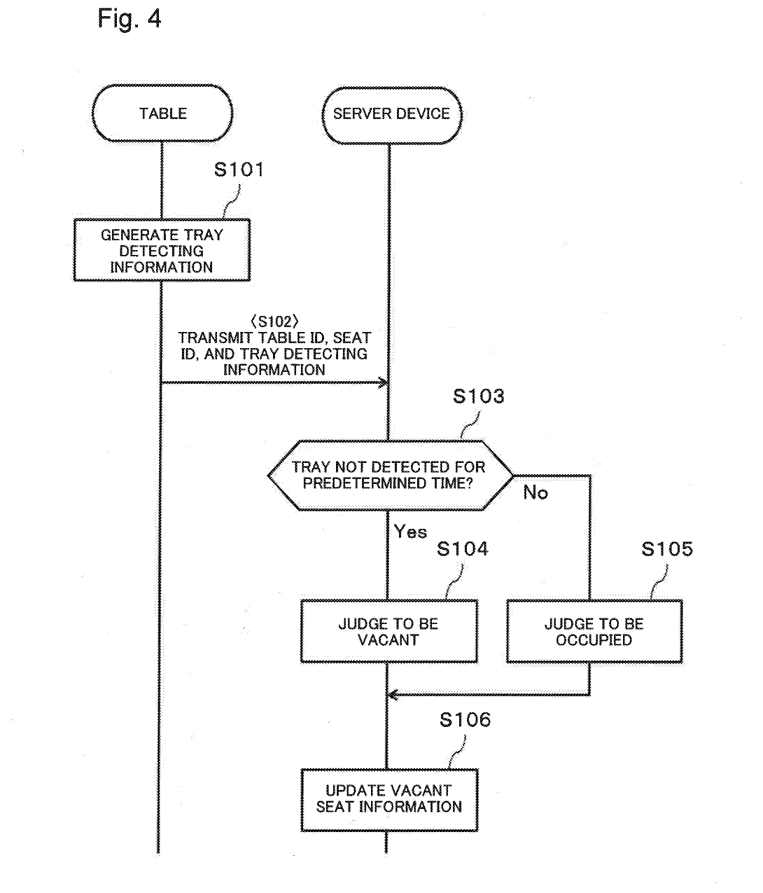

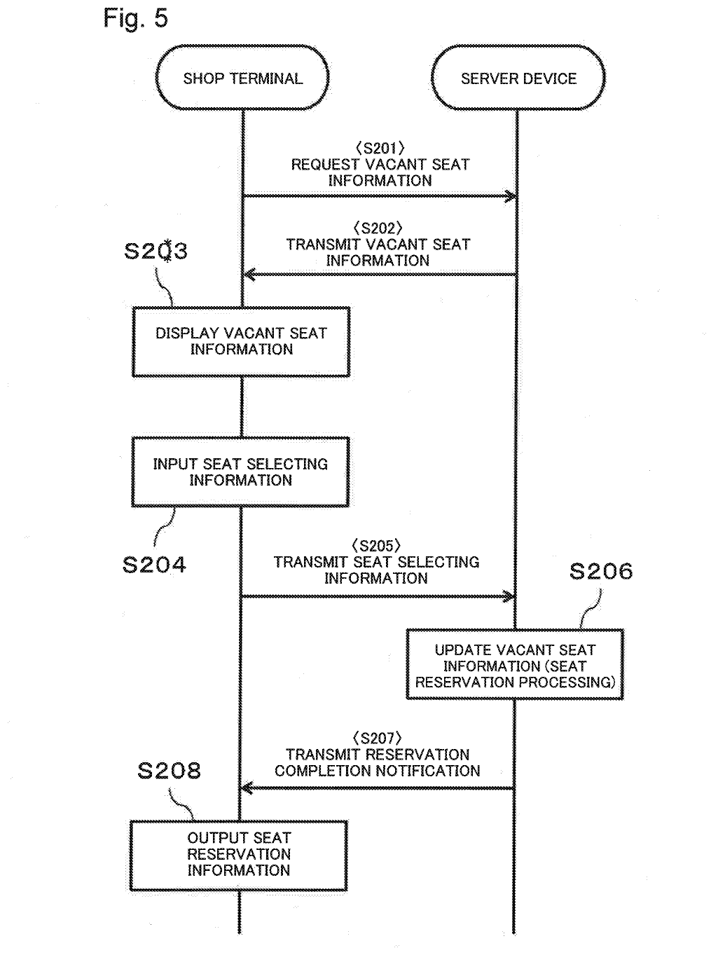

A processing flow of the seat reservation system 1 in the present example embodiment is described using FIGS. 4 and 5.

First of all, a flow by the vacant seat information generation unit 210 of generating vacant seat information from a detection result by the tray detection unit 110 is described using FIG. 4. FIG. 4 is a sequence diagram illustrating a processing flow of updating vacant seat information to be performed by the vacant seat information generation unit 210.

First of all, the tray detection unit 110 on the table 10 generates tray detection information indicating a tray detection state (S101). Then, the tray detection unit 110 transmits the tray detection information to the server device 20 in association with a table ID of a table where the tray detection unit 110 is provided, and a seat ID indicating a seat at the table (S102). Processing of Step S101 and processing of Step S102 are performed at a predetermined time interval.

The vacant seat information generation unit 210 in the server device 20 determines whether or not a tray is not continuously detected for a predetermined time by the tray detection unit 110 on the table 10 from a history of information acquired in S102 (S103). When a tray is not continuously detected for a predetermined time by the tray detection unit 110 on the table 10 (YES in S103), the vacant seat information generation unit 210 judges that a seat associated with the tray detection unit 110 is a vacant seat (S104), and updates the vacant seat information (S106). Specifically, when information indicating “occupied” is stored in “use information” of a seat as a determination object by referring to the vacant seat information storage unit 212, the vacant seat information generation unit 210 stores information indicating “vacant” in “use information” of the seat. Further, when information indicating “vacant” is stored in “use information” of a seat as a determination object, the vacant seat information generation unit 210 maintains the information indicating “vacant”. On the other hand, unless otherwise (NO in S103), the vacant seat information generation unit 210 judges that a seat associated with the tray detection unit 110 is “occupied” (S105), and updates the vacant seat information (S106). Specifically, when information indicating “vacant” is stored in “use information” of a seat as a determination object by referring to the vacant seat information storage unit 212, the vacant seat information generation unit 210 stores information indicating “occupied” in “use information” of the seat. Further, when information indicating “occupied” is stored in “use information” of a seat as a determination object, the vacant seat information generation unit 210 maintains the information indicating “occupied”. Herein, when a tray is continuously detected for a predetermined time or longer by the tray detection unit 110, the vacant seat information generation unit 210 may judge that a seat where the tray detection unit 110 is provided is “occupied”. The predetermined time used herein is stored in the vacant seat information generation unit 210 in advance. By configuring as described above, it is possible to prevent that vacant seat information is inadvertently updated when, for example, a customer notices that he/she is seated in a wrong seat, and leaves the seat within a short period of time, and the like. Further, the vacant seat information generation unit 210 may judge that all seats at a table are “occupied”, when a tray is detected by one of a plurality of tray detection units 110 provided on the same table depending on the number of seats.

Note that processing illustrated in S103 to S105 is performed, for example, by causing the vacant seat information generation unit 210 to store a point of time when a target seat is started to be used in a use information column of the vacant seat information storage unit 212, and by acquiring a difference between the point of time and a current point of time. In this case, the point of time when the target seat is started to be used is deleted, when a seat indicating “occupied” in S105 is updated to “vacant”.

The vacant seat information generation unit 210 judges that, when the tray detection unit 110 detects a tray for a seat where “use information” indicates “vacant”, a point of time when the tray is detected is a point of time when the seat is started to be used, for example.

Next, a flow of seat reservation in the shop terminal 30 is described using FIG. 5. FIG. 5 is a sequence diagram illustrating an example of a flow of seat reservation to be performed by the reservation processing unit 220 in the first example embodiment.

First of all, the shop terminal 30 requests the server device 20 to transmit vacant seat information (S201). The server device 20 transmits vacant seat information stored in the vacant seat information storage unit 212 in response to the request (S202). The shop terminal 30 generates a screen capable of identifying a vacant seat in a seat space by using the received vacant seat information, and displays the screen on a display (S203). A staff operating the shop terminal 30 or a customer in the shop confirms the screen displayed on the display, and inputs information (seat selecting information) indicating selecting a desired table and a desired seat via an input device of the shop terminal 30 (S204). The seat selecting information input herein is transmitted to the server device 20 (S205). The seat selecting information includes information (table ID) for identifying a table to be reserved by a customer, and information (seat ID) for identifying a seat.

The reservation processing unit 220 in the server device 20 updates the vacant seat information in the vacant seat information storage unit 212 by using the table ID and the seat ID of the received seat selecting information, and performs seat reservation processing (S206). Specifically, the reservation processing unit 220 refers to the vacant seat storage information 212 by using a seat ID of seat selecting information, and stores information indicating that a seat is reserved in “reservation information” of the seat ID. Thus, seat reservation processing is completed. When the reservation processing is completed, the server device 20 transmits, to the shop terminal 30, a notification indicating that reservation is completed (S207). When the shop terminal 30 receives the notification, the seat reservation information output unit 310 outputs information (seat reservation information) indicating the reserved seat by using an input of S204 (S208). For example, the seat reservation information output unit 310 print-outputs, on a paper medium, a seat number of a reserved seat and a map indicating a position of the seat by using the printing device 3053 illustrated in FIG. 3, for example. Further, the seat reservation information output unit 310 may output seat reservation information to a mobile terminal of a customer by short-range wireless communication, a mail, or the like.

[Operations and Advantageous Effects of First Example Embodiment]

As described above, in the present example embodiment, a presence or absence of a tray is detected by the tray detection unit 110 provided for each seat at a table, and vacant seat information indicating a vacant seat in a seat space is generated by using a tray detection result by the tray detection unit 110. Thus, it is possible to grasp a usage status of each seat in a seat space by a presence or absence of a tray. Further, when a tray is not continuously detected for a predetermined time or longer by the tray detection unit 110, it is judged that a seat where the tray detection unit 110 is provided is “vacant”. Since a customer returns a tray to a predetermined return slot after using the seat, the tray is not detected any longer by the tray detection unit 110. In other words, it can be said that a seat for which a tray is not detected for a predetermined time or longer is highly likely to be a vacant seat. Thus, according to the present example embodiment, it is possible to accurately judge a usage status of each seat only by using a detection result by the tray detection unit 110. Further, it is not necessary to provide a further configuration for enhancing judgment accuracy on a usage status for each seat, and it is possible to suppress a cost increase.

### Second Example Embodiment

When a group of several persons such as a family and acquaintances visit a seat space, each person may individually purchase commodity at different shops according to his/her preference. In this case, it is necessary to provide a configuration, in which seats are not separated when the seats are reserved as described in the first example embodiment.

[System Configuration]

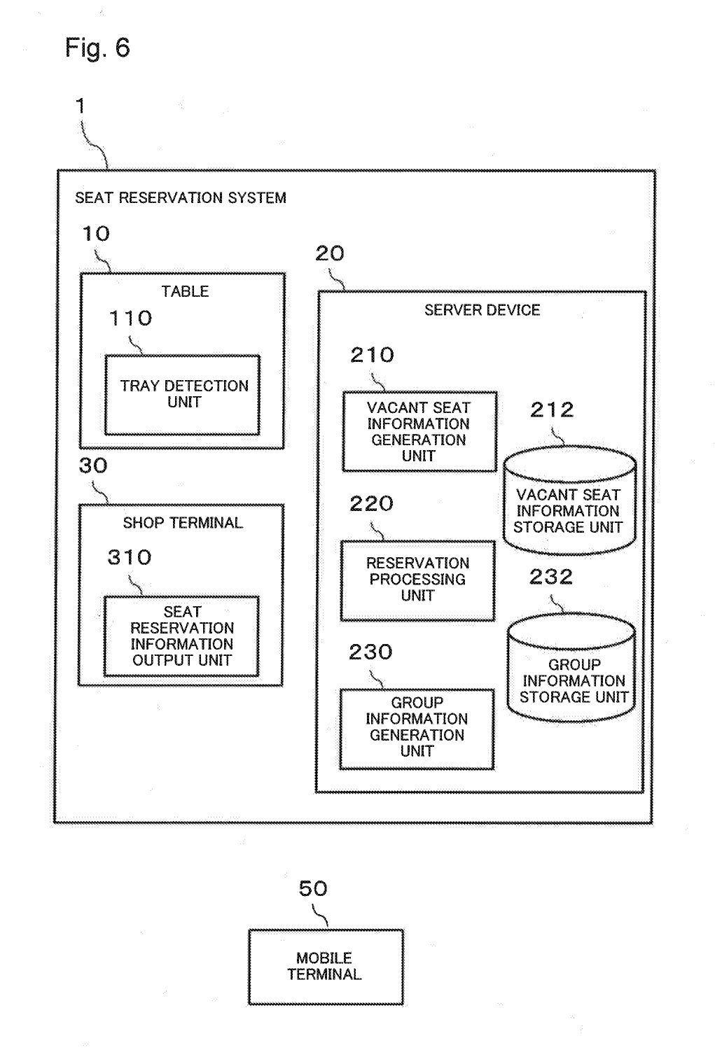

FIG. 6 is a diagram conceptually illustrating a system configuration of a seat reservation system 1 in a second example embodiment. As illustrated in FIG. 6, a server device 20 in the present example embodiment further includes a group information generation unit 230 and a group information storage unit 232, in addition to a configuration of the first example embodiment. In an example of FIG. 6, the group information storage unit 232 is provided in the server device 20. Alternatively, the group information storage unit 232 may be provided in an external device communicatively connected to the server device 20. Note that a mobile terminal 50 is a smartphone, a mobile phone, a tablet terminal, or the like owned by a customer. As will be described later in detail, the mobile terminal 50 receives information for identifying each group in the present example embodiment.

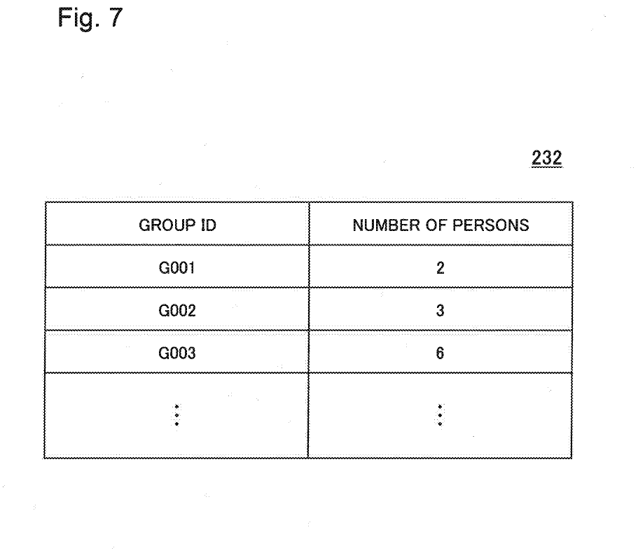

The group information generation unit 230 generates group information for identifying a group to which a customer belongs. The group information includes at least information for identifying each group. Further, the group information may be associated with information indicating the number of persons in the group. Specifically, the group information generation unit 230 generates information as illustrated in FIG. 7, and stores the information in the group information storage unit 232.

FIG. 7 is a diagram illustrating an example of information stored in the group information storage unit 232. In an example of FIG. 7, the group information storage unit 232 stores information indicating the number of persons in a target group in association with information (group ID) for identifying each group.

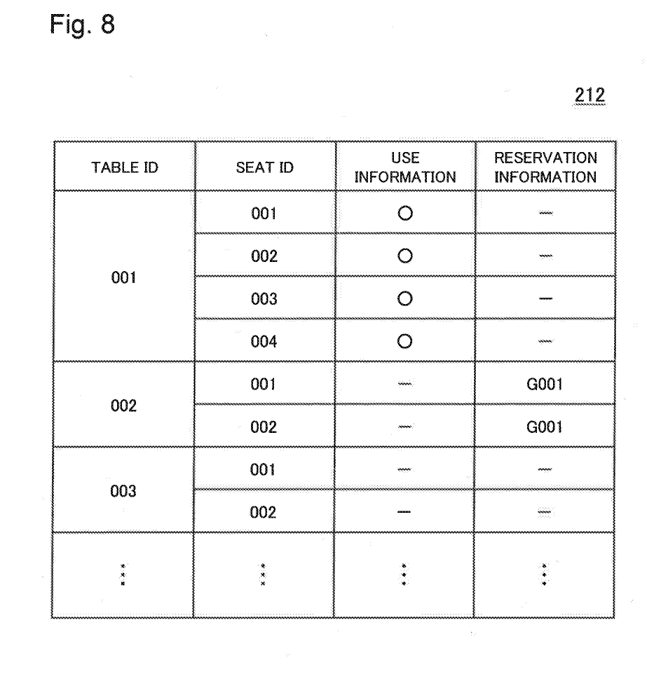

A reservation processing unit 220 in the present example embodiment stores group information generated by the group information generation unit 230, and information indicating a reserved seat into a vacant seat information storage unit 212 in association with each other. Specifically, the group information generation unit 230 acquires group information of a group to which a target customer belongs when a seat is reserved, and updates vacant seat information in the vacant seat information storage unit 212, as illustrated in FIG. 8, for example.

FIG. 8 illustrates an example of information stored in the vacant seat information storage unit 212 in the second example embodiment. In an example of FIG. 8, a group ID for identifying each group is stored in a “reservation information” column of each seat. A “reservation information” section in FIG. 8 indicates a relationship between each group and a reservation seat. By referring to the “reservation information” section, the system is able to grasp by which group, each table and seats are used.

[Hardware Configuration]

The seat reservation system 1 in the present example embodiment has a same hardware configuration as in the first example embodiment. A storage 203 in the present example embodiment further stores a program for implementing a function of the group information generation unit 230. By causing a processor 201 to execute the program, the group information generation unit 230 is implemented. Further, the storage 203 also functions as the group information storage unit 232.

[Operation Example]

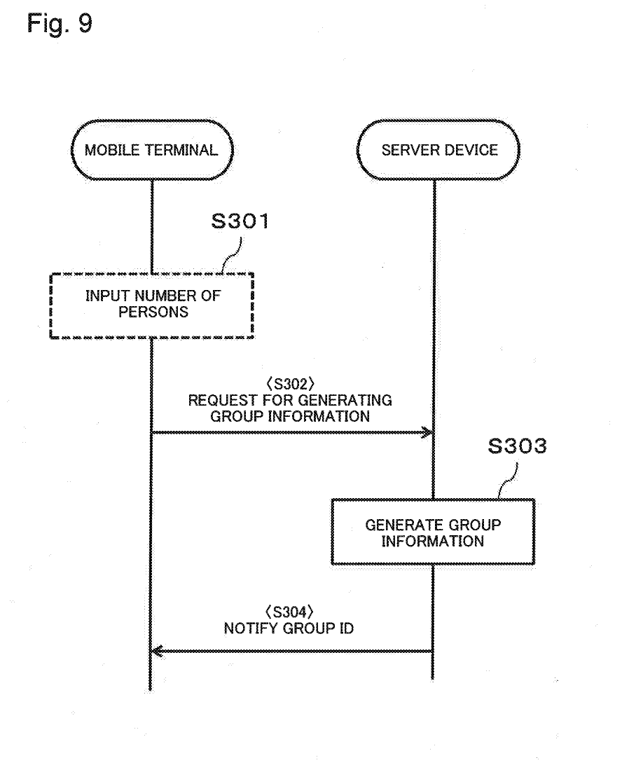

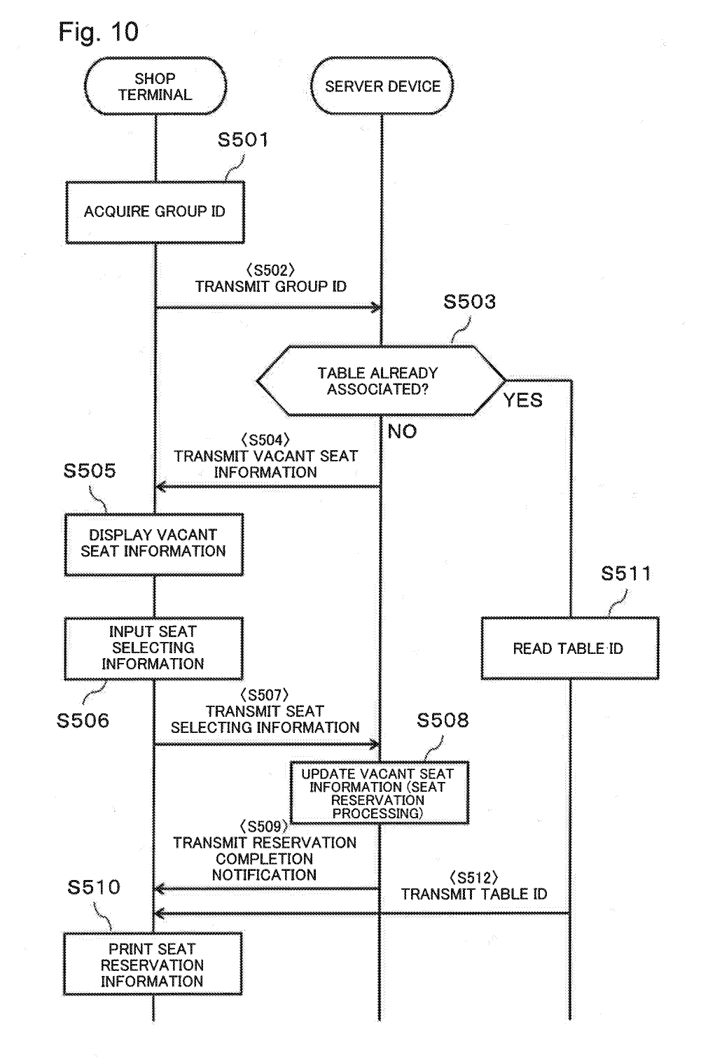

A processing flow of the seat reservation system 1 in the present example embodiment is described using FIGS. 9 and 10.

First of all, a flow of generating group information by the group information generation unit 230 is described using FIG. 9. FIG. 9 is a sequence diagram illustrating a processing flow of generating group information by the group information generation unit 230. Note that in an example of FIG. 9, a flow by the server device 20 of generating group information from the mobile terminal 50 of a customer in response to a request for generating group information is described. Note that processing illustrated in FIG. 9 may be performed by using a software exclusively installed in the mobile terminal 50, or may be performed by using a browser installed in the mobile terminal 50, for example.

First of all, when the number of persons included in a group is input by the mobile terminal 50 (S301), a request for generating group information is transmitted from the mobile terminal 50 to the server device 20 together with the input number of persons (S302). Note that in the present example embodiment, the number of persons in a group is not necessarily required. Upon receiving a request for generating group information, the group information generation unit 230 in the server device 20 generates identification information (group ID) that is uniquely determined for each group. Then, when an input indicating the number of persons is received in S301, as illustrated in FIG. 7, the group information generation unit 230 stores, in the group information storage unit 232, the generated group ID and information indicating the number of persons input in S301 in association with each other (S303). Then, the group information generation unit 230 notifies the mobile terminal 50 of the generated group ID by using short-range wireless communication, a mail, or the like, for example (S304). Note that the group information generation unit 230 notifies the group ID to the mobile terminal 50 of a leader within the group. Thereafter, the mobile terminal 50 of the leader transfers the group ID to the mobile terminals 50 of the other members. Thus, one group ID is shared within one group. Note that the other members may receive the group ID by using another method. For example, when an address of each member is included in a request for generating group information, the group information generation unit 230 may also notify each member of the generated group ID by using these addresses.

FIG. 10 is a sequence diagram illustrating an operation example of the server device 20 and a shop terminal 30 when seat reservation is performed by using a group ID. First of all, each member in a group notifies a shop staff of a group ID when commodity is ordered at a shop. Then, the shop staff inputs the group ID in the shop terminal 30 (S501). Note that the group ID may be input to the shop terminal 30 by using another method (e.g. short-range wireless communication from the mobile terminal 50). Next, the shop terminal 30 transmits the group ID to the server device 20 (S502).

The reservation processing unit 220 in the server device 20 judges whether or not the group ID transmitted in S502 is already stored in a reservation information column of the vacant seat information storage unit 212, in other words, whether or not the group ID is already associated with one of the tables (S503).

When the group ID is already associated with one of the tables (YES in S503), the reservation processing unit 220 reads, from the vacant seat information storage unit 212, a table ID associated with the group ID (S511), and transmits the read table ID to the shop terminal 30 (S512).

On the other hand, when the group ID is not yet associated with one of the tables (NO in S503), the reservation processing unit 220 reads the vacant seat information from the vacant seat information storage unit 212, and transmits the read vacant seat information to the shop terminal 30 (S504). The shop terminal 30 generates a screen capable of identifying a vacant seat in a seat space by using the received vacant seat information, and displays the screen on a display (S505). A shop staff operating the shop terminal 30 or a customer in the shop confirms the screen displayed on the display, and inputs information (seat selecting information) indicating selecting a desired seat via an input device of the shop terminal 30 (S506). Then, the shop terminal 30 transmits the input seat selecting information to the server device 20 (S507).

The reservation processing unit 220 in the server device 20 updates the vacant seat information in the vacant seat information storage unit 212 by using the seat ID of the received seat selecting information, and performs seat reservation processing (S508). The processing to be performed herein is the same as the processing described in S206 in FIG. 5, for example. When reservation processing is completed, the server device 20 transmits, to the shop terminal 30, a notification indicating that reservation is completed (S509).

Then, the shop terminal 30 outputs the information (seat reservation information) received in S509, or the table ID received in Step S512 (S510). Details on the processing to be performed herein are the same as the processing described in S208 in FIG. 5, for example.

[Operations and Advantageous Effects of Second Example Embodiment]

As described above, according to the present example embodiment, it is possible to accurately judge a usage status of each seat only by using a detection result by a tray detection unit 110 in the same manner as in the first example embodiment. Further, it is not necessary to provide a further configuration for enhancing judgment accuracy of a usage status for each seat, and it is possible to suppress a cost increase. Further, when a plurality of persons belonging to a same group use the seat reservation system 1, it is possible to perform seat reservation for each group.

### Third Example Embodiment

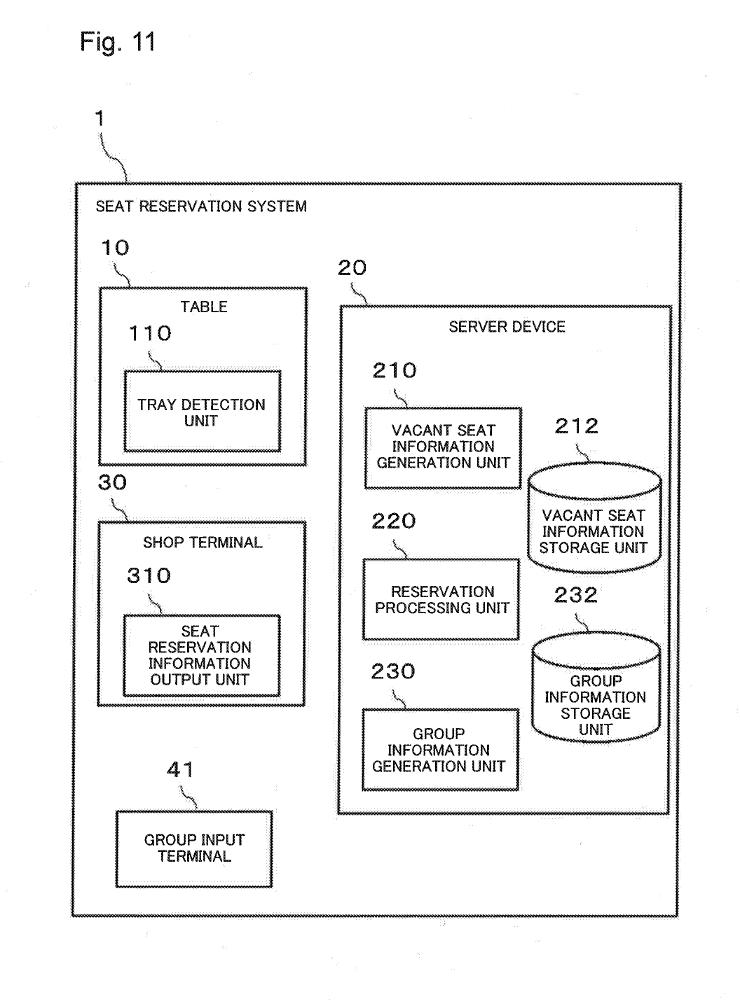

FIG. 11 is a diagram conceptually illustrating a system configuration of a seat reservation system 1 in a third example embodiment. The seat reservation system 1 illustrated in FIG. 11 has a same configuration as the seat reservation system 1 according to the second example embodiment except for a point that the seat reservation system 1 includes a group input terminal 41.

The group input terminal 41 is used when a group registration is performed with respect to a server device 20. In other words, in the present example embodiment, group registration is performed by using the group input terminal 41, in place of a mobile terminal 50.

[Hardware Configuration]

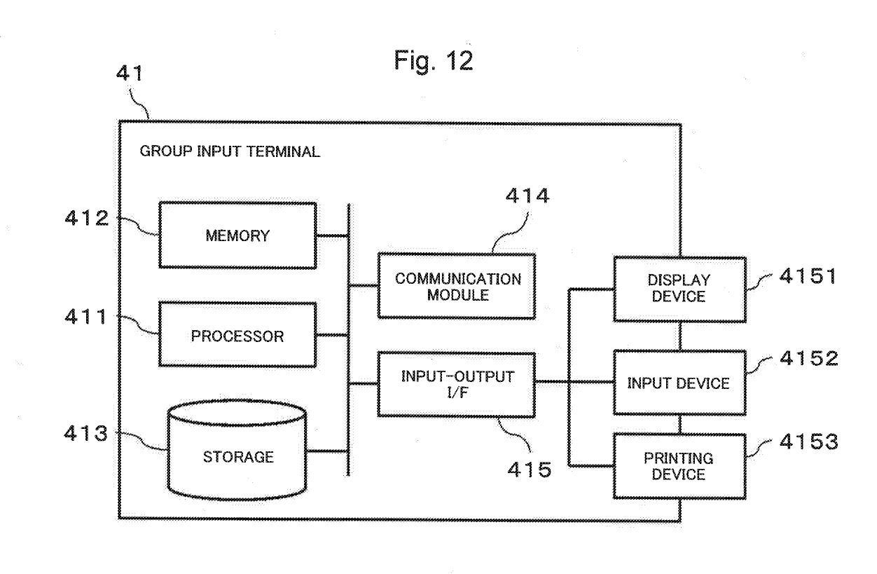

A hardware configuration of the seat reservation system 1 in the present example embodiment is the same as a configuration illustrated in FIG. 3 except for a point that the seat reservation system 1 further includes the group input terminal 41. FIG. 12 is a diagram conceptually illustrating a hardware configuration of the group input terminal 41.

The group input terminal 41 includes a processor 411, a memory 412, a storage 413, a communication module 414, and an input-output interface (I/F) 415. The processor 411, the memory 412, the storage 413, the communication module 414, and the input-output interface 415 are connected by a data transmission path for mutually transmitting and receiving data.

The processor 411, the memory 412, and the storage 413 are the same as those in the server device 20, and the like. Various programs for implementing a function of the group input terminal 41 are stored in the storage 413. By causing the processor 411 to execute these programs, various functions of the group input terminal 41 are implemented.

The input-output interface 415 is connected to a display device 4151, an input device 4152, a printing device 4153, and the like. The display device 4151 is a device for displaying a screen associated with drawing data processed by the processor 411, such as an LCD and a CRT display. The input device 4152 is a device for receiving an operation input by an operator, and is a keyboard, a mouse, a touch sensor, and the like, for example. The display device 4151 and the input device 4152 may be integrally formed, and implemented as a touch panel. The printing device 4153 is the same as a printing device 3053, and is operated according to a control command to be transmitted from the processor 411.

The communication module 414 transmits and receives data to and from an external device via a wired network or a wireless network. The group input terminal 41 transmits, to the server device 20, a request for transmitting group information by using the communication module 414, and receives group information transmitted from the server device 20 in response to the transmission request.

[Operation Example]

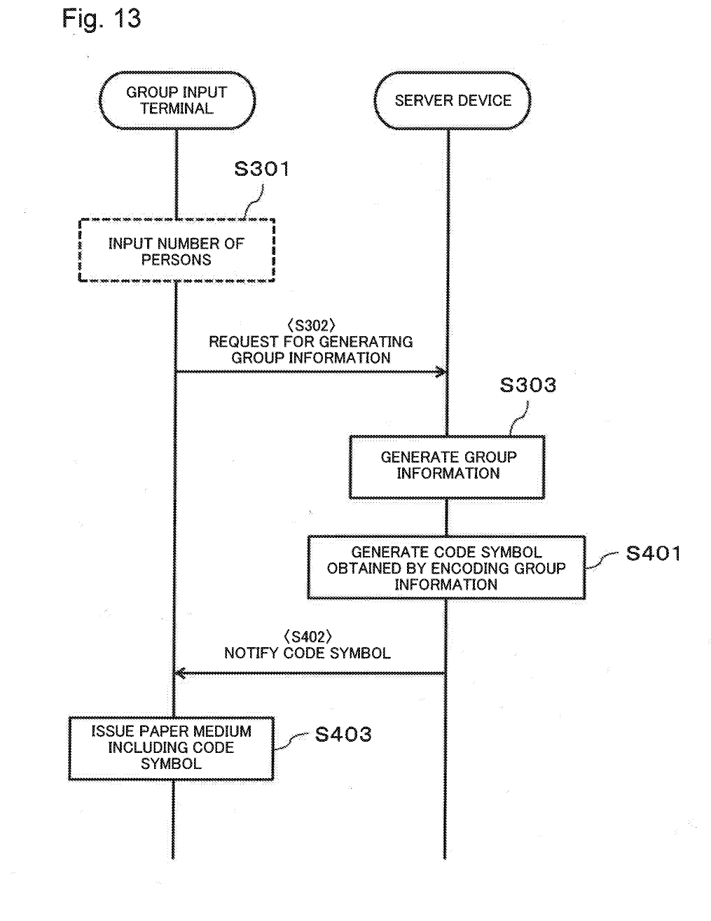

FIG. 13 is a sequence diagram illustrating a flow of generating group information by a group information generation unit 230 in the present example embodiment. Processing illustrated in S301 to S303 in FIG. 13 is the same as processing illustrated in S301 to S303 in FIG. 9. Specifically, a user who performs processing inputs the number of persons included in a group to the group input terminal 41 (S301). Then, the group input terminal 41 transmits, to the server device 20, a request for generating group information (S302). Upon receiving a request for generating group information, the group information generation unit 230 in the server device 20 generates identification information (group ID) that is uniquely determined for each group. Then, the group information generation unit 230 stores, in a group information storage unit 232, the generated group ID and information indicating the number of persons input in S301 in association with each other (S303).

Then, the group information generation unit 230 generates a code symbol indicating group information by encoding the generated group information (S401). Then, the group information generation unit 230 notifies the group input terminal 41 of the generated code symbol (S402). The group input terminal 41 prints the received code symbol on a paper medium (S403).

Note that in the present example embodiment, group information may not be encoded. In this case, 41 directly prints group information on a paper medium.

[Operations and Advantageous Effects of Third Example Embodiment]

Also in the present example embodiment, when a plurality of persons belonging to a same group use the seat reservation system 1, it is possible to perform seat reservation for each group in the same manner as in the second example embodiment. Further, a person who does not own a mobile terminal 50 is able to perform seat reservation for each group.

### Fourth Example Embodiment

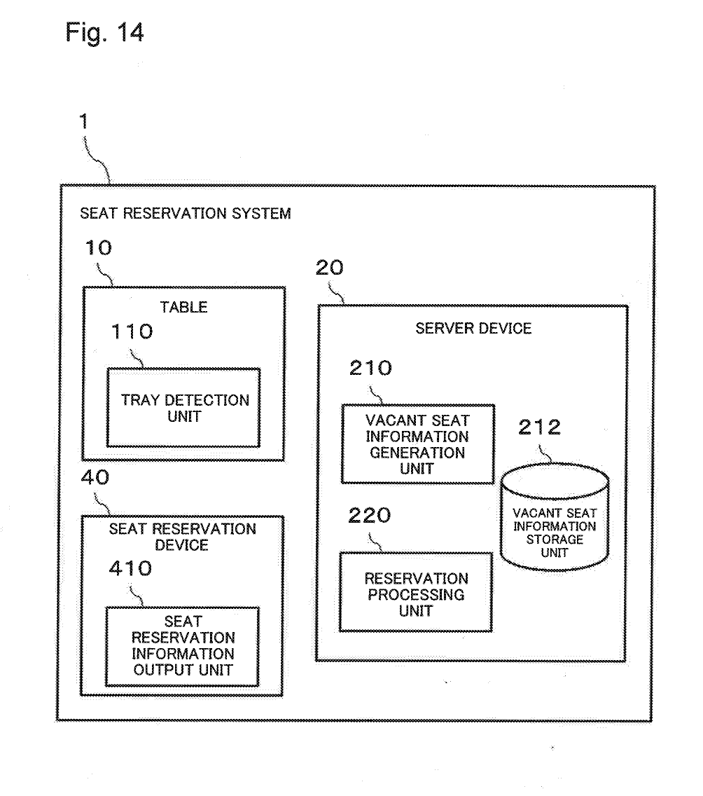

FIG. 14 is a diagram conceptually illustrating a system configuration of a seat reservation system 1 according to a fourth example embodiment. The seat reservation system 1 according to the present example embodiment has a same configuration as the seat reservation system 1 according to the first example embodiment except for a point that seat reservation is performed by a seat reservation device 40, in place of a shop terminal 30.

The seat reservation device 40 includes a seat reservation information output unit 410. A function of the seat reservation information output unit 410 is the same as a function of a seat reservation information output unit 310 in the first example embodiment.

[Hardware Configuration]

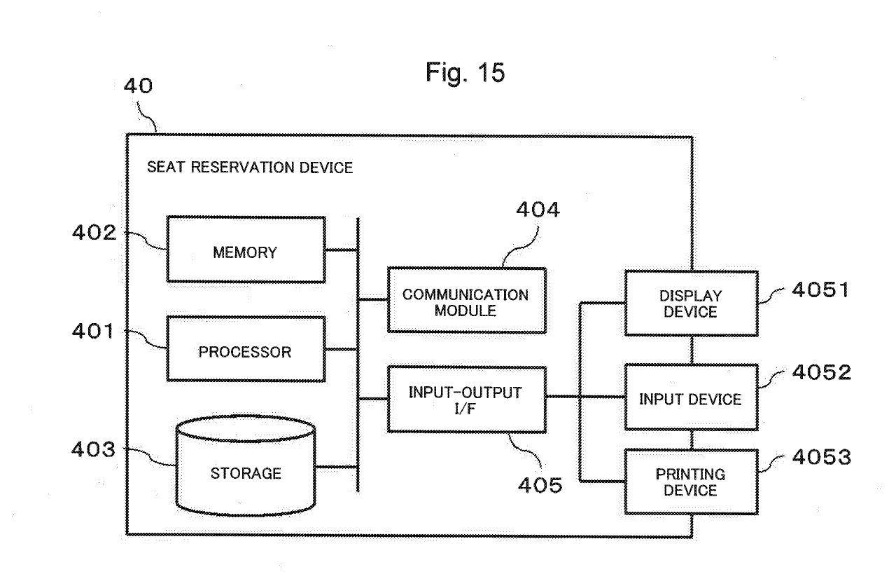

FIG. 15 is a diagram conceptually illustrating a hardware configuration of the seat reservation device 40 in the fourth example embodiment. The seat reservation device 40 includes a processor 401, a memory 402, a storage 403, a communication module 404, and an input-output interface (I/F) 405. The processor 401, the memory 402, the storage 403, the communication module 404, and the input-output interface 405 are connected by a data transmission path for mutually transmitting and receiving data. The storage 403 stores a program for implementing a function of the seat reservation information output unit 410. The seat reservation information output unit 410 is implemented by causing the processor 401 to execute this program.

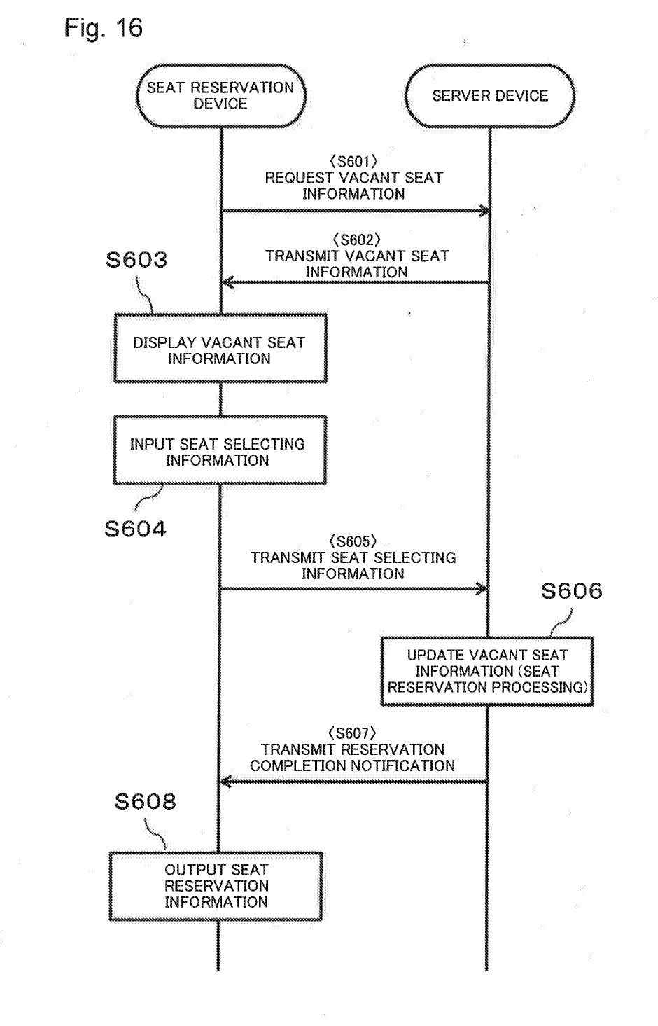

FIG. 16 is a sequence diagram illustrating an example of an operation to be performed by the seat reservation device 40 together with an operation of a server device 20. Processing (S601 to S608) illustrated in FIG. 16 is the same as processing (S201 to S208) illustrated in FIG. 5 of the first example embodiment.

Note that in the second example embodiment and the third example embodiment, the seat reservation device 40 may be used in place of the shop terminal 30.

[Operations and Advantageous Effects of Fourth Example Embodiment]

As described above, according to the present example embodiment, it is possible to accurately judge a usage status of each seat only by using a detection result by a tray detection unit 110 in the same manner as in the first example embodiment.

### Fifth Example Embodiment

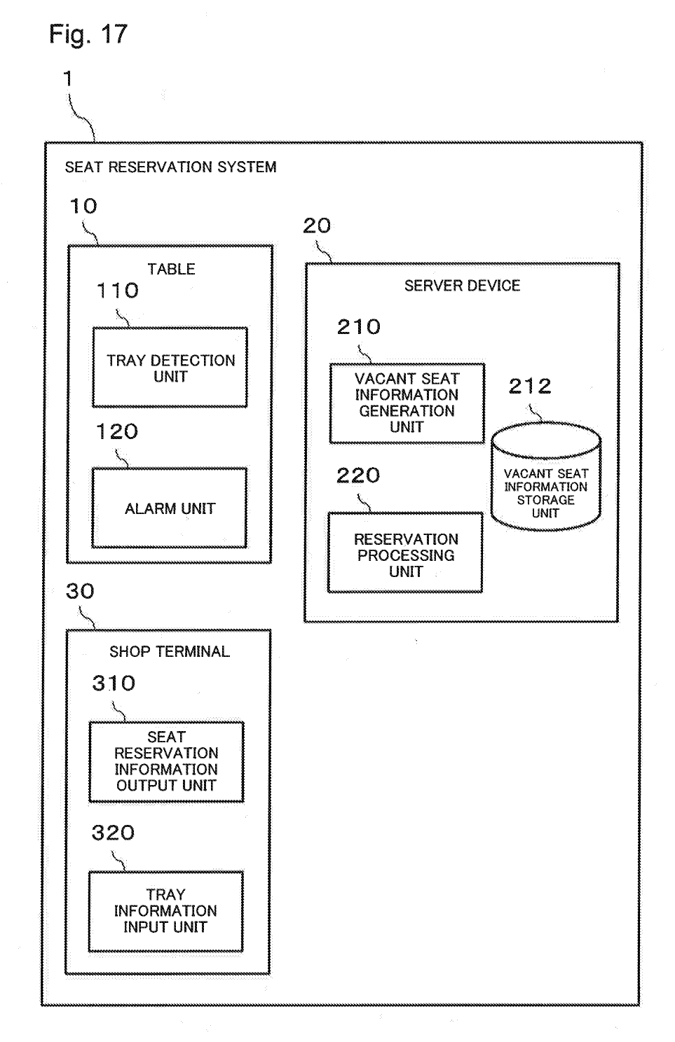

FIG. 17 is a diagram conceptually illustrating a system configuration of a seat reservation system 1 according to a fifth example embodiment. The seat reservation system 1 according to the present example embodiment has a same configuration as the seat reservation system 1 according to the first example embodiment except for a point that a table 10 includes an alarm unit 120, and a point that a shop terminal 30 includes a tray information input unit 320.

In the present example embodiment, tray identification information is allocated to each of a plurality of trays. The tray identification information is stored in an IC tag attached to a tray, for example. Further, when a seat is reserved, tray identification information is associated with the reserved seat. Further, when a tray including tray identification information other than tray identification information associated with a certain table is placed on the table, the alarm unit 120 outputs an alarm.

[Hardware Configuration]

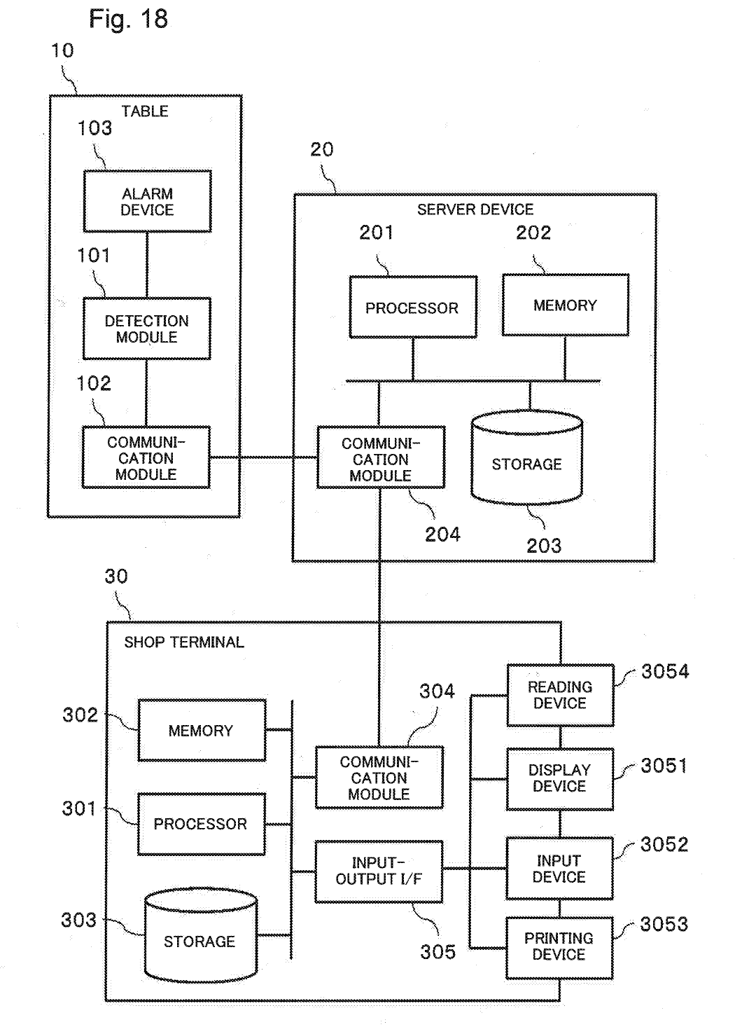

FIG. 18 is a diagram conceptually illustrating a hardware configuration of the seat reservation system 1 in the fifth example embodiment. The seat reservation system 1 in the present example embodiment is different from the first example embodiment in a point that the table 10 further includes an alarm device 103, and in a point that the shop terminal 30 further includes a reading device 3054. The alarm device 103 includes a sound output device such as a buzzer for outputting a certain sound, and a light emitting device including a light emitting diode (LED) and the like. Further, the reading device 3054 is a device for reading an IC tag or the like attached to a tray.

[Operation Example]

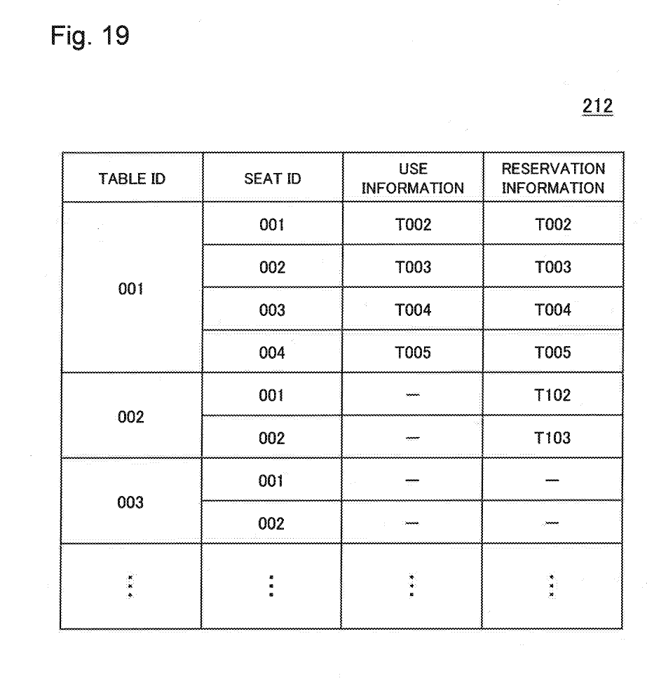

Note that details on processing by the alarm unit 120 and the tray information input unit 320 will be described later using FIG. 19 to FIG. 21.

FIG. 19 is a diagram illustrating an example of a data configuration of a vacant seat information storage unit 212 in the present example embodiment. In an example illustrated in FIG. 19, the vacant seat information storage unit 212 stores, as information indicating that a target seat is occupied, tray identification information of a tray used for the seat. The tray identification information is read by a tray detection unit 110 on the table 10. In other words, in the present example embodiment, the tray detection unit 110 reads tray identification information from a tray, and transmits, to a server device 20, the read tray identification information in association with a table ID of a table where the tray detection unit 110 is provided and a seat ID for identifying a seat at the table.

Further, the vacant seat information storage unit 212 stores, as information indicating that the seat is reserved, tray identification information of a tray which is supposed to be used for the seat. The tray identification information is information input by the tray information input unit 320 of the shop terminal 30.

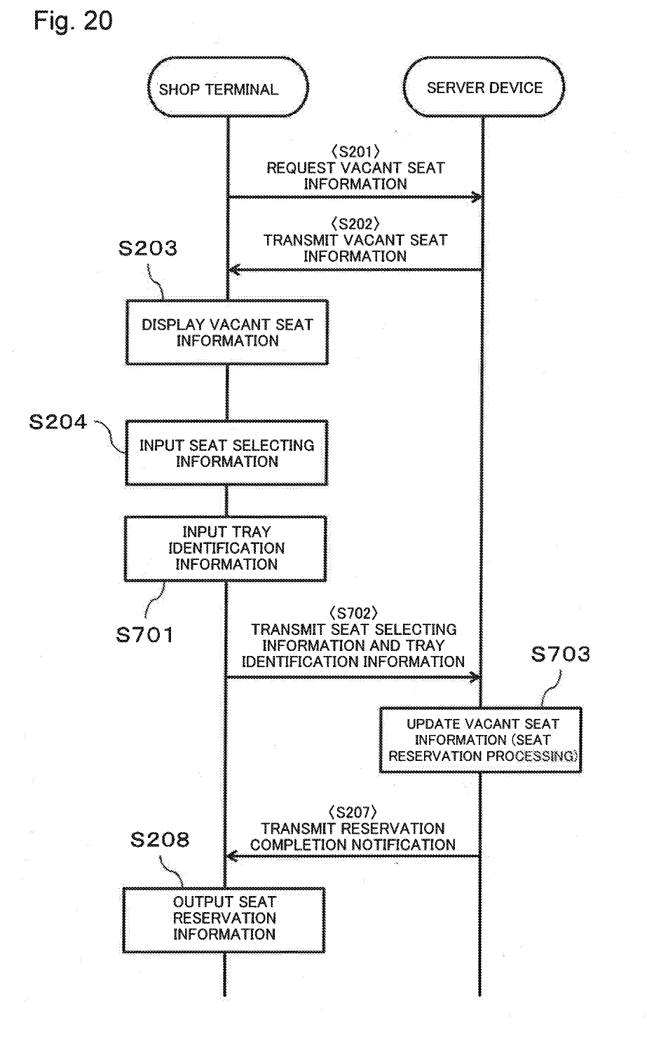

FIG. 20 is a sequence diagram illustrating an operation of the server device 20 and the shop terminal 30 when a seat is reserved in the seat reservation system 1 in the present example embodiment. Processing from S201 to S204 is the same as processing illustrated in FIG. 5.

A shop staff inputs information (seat selecting information) indicating selecting a desired seat via an input device of the shop terminal 30 (S204), and inputs, to the tray information input unit 320, tray identification information of a tray to be used by a customer who is supposed to be seated in the seat (S701). When the tray information input unit 320 is an IC tag reader, this input is performed by user's holding a tray over the tray information input unit 320. Then, the shop terminal 30 transmits, to the server device 20, the seat selecting information input in S204 in association with the tray identification information input in S701 (S702).

A reservation processing unit 220 in the server device 20 updates vacant seat information in a vacant seat information storage unit 212 by using the table ID and the seat ID of the received seat selecting information, and the tray identification information, and performs seat reservation processing (S703). Specifically, the reservation processing unit 220 refers to the vacant seat information storage unit 212 by using a seat ID of seat selecting information, and stores tray identification information in “reservation information” of the seat ID. Thus, seat reservation processing is completed. Processing thereafter (S207 and S208) is the same as processing illustrated in FIG. 5.

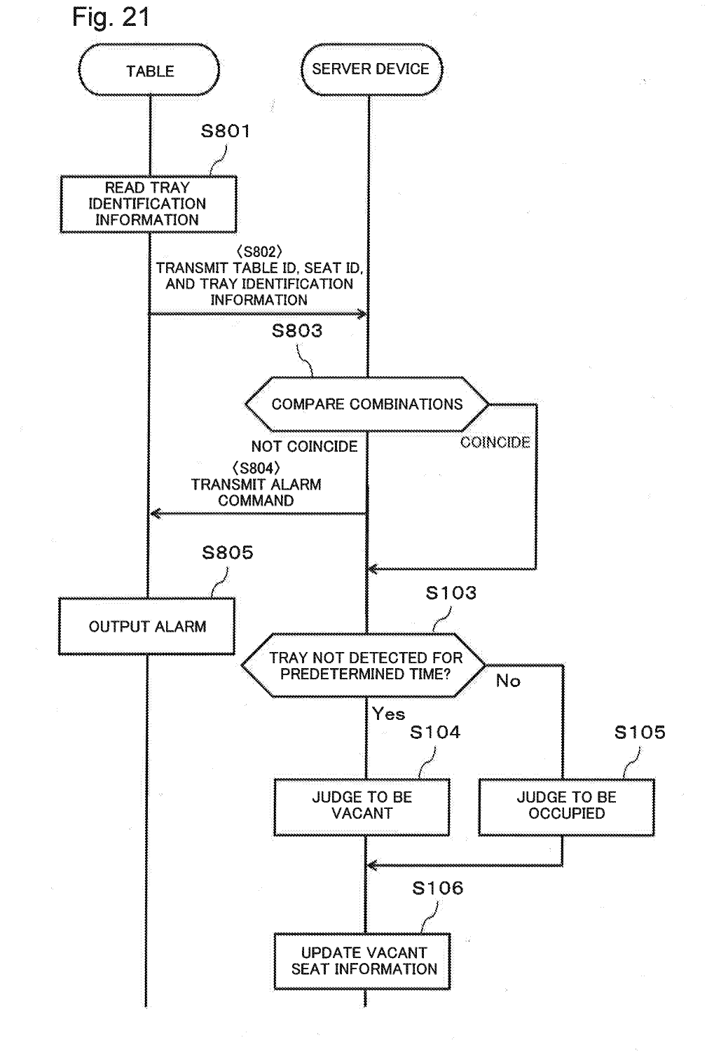

FIG. 21 is a sequence diagram illustrating an operation of the table 10 and the server device 20 when a customer uses a reserved seat in the seat reservation system 1 in the present example embodiment. A customer places a tray on the table 10 when the reserved seat is used. Then, the tray detection unit 110 on the table 10 reads tray identification information of the placed tray (S801), and transmits, to the server device 20, the read tray identification information in association with the table ID of the table and the seat ID (S802).

Then, the reservation processing unit 220 in the server device 20 reads, from the vacant seat information storage unit 212, tray identification information associated with the table ID and the seat ID transmitted in S801. Then, the reservation processing unit 220 judges whether or not the read tray identification information coincides with the tray identification information transmitted in S802 (S803). When these pieces of information do not coincide with each other, the reservation processing unit 220 transmits an alarm command to the alarm unit 120 on the table 10 (S804). Upon receiving the alarm command, the alarm unit 120 on the table 10 issues an output indicating that the customer is seated in a wrong seat. (S805). This output is performed by outputting a sound, for example. When the table 10 includes a display, however, the alarm unit 120 may cause the display to indicate that the customer is seated in a wrong seat.

Note that when the read tray identification information coincides with the tray identification information transmitted in S802, the tray detection unit 110 on the table 10 performs processing illustrated in S103 to S105. These processing is the same as processing illustrated in S103 to S105 in FIG. 4.

[Operations and Advantageous Effects of Fifth Example Embodiment]

Also in the present example embodiment, it is possible to accurately judge a usage status of each seat only by using a detection result by the tray detection unit 110. Further, when a customer is attempted to use a wrong table and a wrong seat, the alarm unit 120 on the table 10 issues an output indicating that the customer is seated in a wrong seat. Therefore, it is possible to prevent that a customer is attempted to use a wrong table and a wrong seat.

Note that in the second example embodiment, the third example embodiment, and the fourth example embodiment, same processing as in the present example embodiment may be performed.

In the foregoing, example embodiments of the present invention are described with reference to the drawings. These example embodiments, however, are examples of the present invention. Various configurations other than the above may be employed.

Further, in the plurality of sequence diagrams used in the aforementioned description, a plurality of steps (processing) are described in an order. However, an execution order of steps to be performed in each example embodiment is not limited to the described order. In each of the example embodiments, it is possible to modify the illustrated order of steps as far as the modification does not deviate from the present invention in terms of content. Further, it is possible to combine the aforementioned example embodiments, as far as contents are not contradictory to each other.

The whole or part of the example embodiments disclosed above can be described as, but not limited to, the following supplementary notes.

1.

A seat reservation system including:

a tray detection means provided for each seat at a table, and configured to detect a presence or absence of a tray;

a vacant seat information generation means for generating vacant seat information indicating that a seat for which a tray is not continuously detected for a predetermined time or longer by the tray detection means is a vacant seat;

a reservation processing means for performing seat reservation processing by using the vacant seat information; and

a seat reservation information output means for outputting seat reservation information indicating a seat reserved by the reservation processing.

2.

The seat reservation system according to 1., further including:

a group information generation means for generating group information for identifying a group to which a customer belongs, wherein

the reservation processing means

stores the group information and information indicating a reserved seat in association with each other.

3.

The seat reservation system according to 1. or 2., wherein

the vacant seat information generation means

judges that a seat for which the tray is continuously detected for the predetermined time or longer by the tray detection means is an occupied seat.

4.

The seat reservation system according to any one of 1. to 3.,wherein

a plurality of the tray detection means are provided, and

the vacant seat information generation means

judges that, when the tray is detected by one of the plurality of the tray detection means provided at one table, all seats at the table are occupied.

5.

The seat reservation system according to any one of 2. to 4.,wherein

the seat reservation information output means

determines whether or not a seat associated with the group information is already present, and when the seat is present, outputs information indicating the seat.

6.

The seat reservation system according to any one of 1. to 5., further including:

an alarm means for outputting a predetermined alarm, wherein

the tray includes a tray identification information storage means for storing tray identification information uniquely given for each tray,

the reservation processing means

stores, in a storing means, table identification information of a table including the seat reserved by the reservation processing, and the tray identification information of a tray to be handed to a customer in association with each other,

the tray detection means

acquires the tray identification information from the tray identification information storage means of a detected tray, and

the alarm means

outputs the predetermined alarm, when combination of the tray identification information acquired by the tray detection means and table identification information of the table where the tray detection means is provided is different from combination of the table identification information stored by the reservation processing means and the tray identification information.

7.

An information processing device including:

a vacant seat information generation means for generating vacant seat information indicating that a seat for which a tray is not continuously detected for a predetermined time or longer by a tray detection means for detecting a presence or absence of a tray is a vacant seat; and

a reservation processing means for performing seat reservation processing by using the vacant seat information, wherein the tray detection means is provided for each seat at a table.

8.

The information processing device according to 7., further including:

a group information generation means for generating group information for identifying a group to which a customer belongs, wherein

the reservation processing means stores the group information and information indicating a reserved seat in association with each other.

9.

The information processing device according to 7. or 8., wherein

the vacant seat information generation means

judges that the seat for which a tray is continuously detected for the predetermined time or longer by the tray detection means is an occupied seat.

10.

The information processing device according to any one of supplementary notes 7. to 9., wherein

a plurality of the tray detection means are provided, and

the vacant seat information generation means

judges that, when the tray is detected by one of the plurality of the tray detection means provided at one table, all seats at the table are occupied.

11.

The information processing device according to any one of 8. to 10.,wherein

the seat reservation information output means

determines whether or not a seat associated with the group information is already present, and when the seat is present, outputs information indicating the seat.

12.

The information processing device according to any one of 7. to 11.,further including:

an alarm control means for controlling an alarm device for outputting a predetermined alarm, wherein

the reservation processing means is configured such that

table identification information of a table including a seat reserved by the reservation processing, and tray identification information given to a tray to be handed to a customer and unique to each tray are stored in a storing means in association with each other, and

the alarm control means

transmits, to the alarm device, a control command for outputting the predetermined alarm, when combination of the tray identification information acquired by the tray detection means and table identification information of the table where the tray detection means is provided is different from combination of the table identification information stored by the reservation processing means and the tray identification information.

13.

An information processing method including:

generating vacant seat information indicating that a seat for which a tray is not continuously detected for a predetermined time or longer by a tray detection means is a vacant seat by using a detection result by the tray detection means provided for each seat at a table; and

performing seat reservation processing by using the vacant seat information.

14.

The information processing method according to 13. including:

generating group information for identifying a group to which a customer belongs; and

storing the group information and information indicating a reserved seat in association with each other by the reservation processing.

15.

The information processing method according to 13. or 14. including:

judging that a seat for which the tray is continuously detected for the predetermined time or longer by the tray detection means is an occupied seat.

16.

The information processing method according to any one of 13. to 15. including:

a plurality of the tray detection means are provided, and

judging that, when the tray is detected by one of the plurality of the tray detection means provided at one table, all seats at the table are occupied.

17.

The information processing method according to any one of 14. to 16. including:

determining whether or not a seat associated with the group information is already present, and when the seat is present, outputting information indicating the seat.

18.

The information processing method according to any one of 13. to 17. including:

storing, in a storage means, table identification information of a table including a seat reserved by the reservation processing, and tray identification information given to a tray to be handed to a customer and unique to each tray in association with each other;

acquiring tray identification information from a tray detected by the tray detection means; and

transmitting, to an alarm device, a control command for outputting the predetermined alarm, when combination of the tray identification information acquired by the tray detection means and table identification information of the table where the tray detection means is provided is different from combination of the stored table identification information and the tray identification information.

19.

A program for causing a computer to function as:

a vacant seat information generation means for generating vacant seat information indicating that a seat for which a tray is not continuously detected for a predetermined time or longer by the tray detection means is a vacant seat by using a detection result by the tray detection means provided for each seat at a table;

a reservation processing means for performing seat reservation processing by using the vacant seat information; and

a seat reservation information output means for outputting seat reservation information indicating a seat reserved by the reservation processing.

20.

The program according to 19. for causing the computer to function as:

a group information generation means for generating group information for identifying a group to which a customer belongs; and

the reservation processing means being means for storing the group information and information indicating a reserved seat in association with each other.

21.

The program according to 19. or 20. for causing the computer to further function as:

a means for judging that a seat for which the tray is continuously detected for the predetermined time or longer by the tray detection means is an occupied seat.

22.

The program according to any one of 19. to 21. for causing the computer to further function as:

a means for judging that, when the tray is detected by one of a plurality of the tray detection means provided at one table, all seats at the table are occupied.

23.

The program according to any one of 20. to 22. for causing the computer to further function as:

a means for determining whether or not a seat associated with the group information is already present, and when the seat is present, outputting information indicating the seat.

24.

The program according to any one of 19. to 23. for causing the computer to further function as:

a means for storing, in a storage means, table identification information of a table including a seat reserved by the reservation processing, and tray identification information given to a tray to be handed to a customer and unique to each tray in association with each other; and

a means for outputting to an alarm device, a control command for outputting the predetermined alarm, when combination of the tray identification information acquired by the tray detection means and table identification information of the table where the tray detection means is provided is different from combination of the table identification information stored by the reservation processing means and the tray identification information.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2015-195041, filed on Sep. 30, 2015, the disclosure of which is incorporated herein in its entirety by reference.

### REFERENCE SIGNS LIST

1 Seat reservation system

10 Table

110 Tray detection unit

120 Alarm unit

20 Server device

210 Vacant seat information generation unit

212 Vacant seat information storage unit

220 Reservation processing unit

230 Group information generation unit

232 Group information storage unit

30 Shop terminal

310 Seat reservation information output unit

320 Tray information input unit

40 Seat reservation device

410 Seat reservation information output unit

41 Group input terminal

50 Mobile terminal

What is claimed is:

1.-6 (canceled)

7. An information processing device comprising:
a vacant seat information generation unit which generates vacant seat information indicating that a seat for which a tray is not continuously detected for a predetermined time or longer by a tray detection unit which detects a presence or absence of a tray is a vacant seat; and
a reservation processing unit for performing seat reservation processing by using the vacant seat information, wherein
the tray detection unit is provided for each seat at a table.

8. The information processing device according to claim 7, further comprising:
a group information generation unit which generates group information for identifying a group to which a customer belongs, wherein
the reservation processing unit stores the group information and information indicating a reserved seat in association with each other.

9. An information processing method comprising:
generating vacant seat information indicating that a seat for which a tray is not continuously detected for a predetermined time or longer by a tray detection unit is a vacant seat by using a detection result by the tray detection unit provided for each seat at a table; and
performing seat reservation processing by using the vacant seat information.

10. The information processing method according to claim 9, wherein
group information for identifying a group to which a customer belongs is generated; and
the group information and information indicating a reserved seat are stored in association with each other by the reservation processing.

11. A non-transitory recording medium storing a program for causing a computer to function as:
a vacant seat information generation process for generating vacant seat information indicating that a seat for which a tray is not continuously detected for a predetermined time or longer by a tray detection unit is a vacant seat by using a detection result by the tray detection unit provided for each seat at a table;
a reservation process for performing seat reservation processing by using the vacant seat information; and
a seat reservation information output process for outputting seat reservation information indicating a seat reserved by the reservation process.

12. The non-transitory recording medium according to claim 11 for causing the computer to function as:
a group information generation process for generating group information for identifying a group to which a customer belongs; and
the reservation process being process for storing the group information and information indicating a reserved seat in association with each other.

13. The information processing device according to claim 7, wherein
the vacant seat information generation unit
judges that the seat for which a tray is continuously detected for the predetermined time or longer by the tray detection unit is an occupied seat.

14. The information processing device according to claim 7, wherein
the vacant seat information generation unit
judges that, when the tray is detected by one of a plurality of the tray detection units provided at one table, all seats at the table are occupied.

15. The information processing device according to claim 8, further comprising:
a seat reservation information output unit which outputs seat reservation information indicating a seat reserved by the reservation processing, wherein
the seat reservation information output unit
determines whether or not a seat associated with the group information is already present, and when the seat is present, outputs information indicating the seat.

16. The information processing device according to claim 7, further comprising:
an alarm control unit which controls an alarm device for outputting a predetermined alarm, wherein
the reservation processing unit is configured such that
table identification information of a table including a seat reserved by the reservation processing, and tray identification information given to a tray to be handed to a customer and unique to each tray are stored in a storage in association with each other, and
the alarm control unit
transmits, to the alarm device, a control command for outputting the predetermined alarm, when combination of the tray identification information acquired by the tray detection unit and table identification information of the table where the tray detection unit is provided is different from combination of the table identification information stored by the reservation processing unit and the tray identification information.

17. A seat reservation system comprising:
the information processing device according to claim 7;
a tray detection unit provided for each seat at a table, and configured to detect a presence or absence of a tray; and
a seat reservation information output unit which outputs seat reservation information indicating a seat reserved by the reservation processing.

18. The seat reservation system according to claim 17, further comprising:
a group information generation unit which generates group information for identifying a group to which a customer belongs, wherein
the reservation processing unit
stores the group information and information indicating a reserved seat in association with each other.

19. The seat reservation system according to claim 17, wherein
the vacant seat information generation unit
judges that a seat for which the tray is continuously detected for the predetermined time or longer by the tray detection unit is an occupied seat.

20. The seat reservation system according to claim 17, wherein
a plurality of the tray detection units are provided, and
the vacant seat information generation unit
judges that, when the tray is detected by one of the plurality of the tray detection units provided at one table, all seats at the table are occupied.

21. The seat reservation system according to claim 18, wherein
the seat reservation information output unit
determines whether or not a seat associated with the group information is already present, and when the seat is present, outputs information indicating the seat.

22. The seat reservation system according claim 17, further comprising:
an alarm unit which outputs a predetermined alarm, wherein
the tray includes a tray identification information storage unit which stores tray identification information uniquely given for each tray,
the reservation processing unit
stores, in a storing unit, table identification information of a table including the seat reserved by the reservation processing, and the tray identification information of a tray to be handed to a customer in association with each other,
the tray detection unit
acquires the tray identification information from the tray identification information storage unit of a detected tray, and
the alarm unit
outputs the predetermined alarm, when combination of the tray identification information acquired by the tray detection unit and table identification information of the table where the tray detection unit is provided is different from combination of the table identification information stored by the reservation processing unit and the tray identification information.
